(19) United States
(12) Patent Application Publication
(10) Pub. No.: US 2025/0269580 A1
(43) Pub. Date: Aug. 28, 2025

(54) PROCESSES FOR TEXTURIZING AND MARKING A SURFACE

(71) Applicant: KETER HOME AND GARDEN PRODUCTS LTD., Herzliya (IL)

(72) Inventors: Avi Askof, Kocav Yair (IL); Alex Shuster, Ramat Yishai (IL); Amit Grosser, Kfar Yehezkel (IL)

(21) Appl. No.: 18/858,642

(22) PCT Filed: Apr. 19, 2023
(86) PCT No.: PCT/IL2023/050405

§ 371 Date: Oct. 21, 2024

(30) Foreign Application Priority Data
Apr. 27, 2022 (IL) 292556

(51) Int. Cl. B29C 59/04; B29C 48/00; B29C 48/21; B29K 23/00; B29K 105/04

(52) U.S. Cl. CPC B29C 59/046; B29C 48/002; B29C 48/0012; B29C 48/21; B29K 2023/12; B29K 2105/04; B29K 2995/003

(57) ABSTRACT

The present disclosure concerns texturing and/or marking a surface of a plastic article. more specifically processes for creating textures and marking onto a surface made of foamed plastic material to obtain different reflectivity or different shades by selectively modifying the roughness degree of the surface.

### TECHNOLOGICAL FIELD

The present disclosure concerns texturing and/or marking a surface of a plastic article, more specifically processes for creating textures and marking onto a surface made of plastic material to obtain different reflectivity or different shades.

### BACKGROUND ART

References considered to be relevant as background to the presently disclosed subject matter are listed below:
US patent application publication no. 2007/0235414
U.S. Pat. No. 4,107,247

Acknowledgement of the above references herein is not to be inferred as meaning that these are in any way relevant to the patentability of the presently disclosed subject matter.

### BACKGROUND

Texturing or marking of surfaces, in particularly surfaces made of plastic material, are desired in order to obtain various esthetic effects. By texturization, it is possible to obtain a surface having different degrees of reflection, different tactility, different shades, defined patterns, etc.

Texturization of plastic surfaces, for example of surfaces made of polypropylene, can be carried out in various known techniques, such as engraving, etching, brushing, laser treatment, plasma treatment, corona treatment, etc. These techniques typically involve removal of material from the surface of the article by different mechanisms, such as ablation, engraving, or by local chemical modification of the surface; these techniques often require utilization of expensive equipment. Other techniques involve printing onto the surface, however due to the significant differences in surface tension and chemical compatibility between the plastic surface and the printing ink, it is often required to first apply one or more primer compositions onto the surface. Such surface printing often involves hazardous materials, as well as requiring further processing steps and equipment.

### GENERAL DESCRIPTION

The present disclosure provides a process for obtaining a texturized article, i.e. an article having a texture on its surface, with regions of different textures and light reflectivity. Contrary to known processes, in which a smooth surface is first obtained and then texturized, in a process of this disclosure the article is first produced with a rough surface, and then processed to selectively reduce the degree of roughness in one or more regions, thereby obtaining the desired texture, resulting in regions having different roughness and different light reflectivity. The processes of this disclosure provide a simpler and more cost-effective manner to produce an article having a desired textured surface. The processes of this disclosure can also be used to mark a surface with different markings, such as lettering, numbers, symbols, etc.

By a first aspect of this disclosure, there is provided a process for texturizing a surface made of a thermoplastic polymeric material to obtain a textured surface having areas of different roughness grades, the process comprising: providing a foamed surface made of foamed thermoplastic polymeric material, the foamed surface having a first roughness grade; melting the foamed thermoplastic material at one or more regions of the foamed surface to cause reduction of roughness in said one or more regions to a second roughness grade, thereby obtaining said textured surface.

By another one of its aspects, this disclosure provides a process for providing an article having a textured surface comprising regions of different light reflectivity, the process comprising: providing a foamed surface made of foamed thermoplastic polymeric material to obtain a first light reflectivity of the foamed surface; and melting the foamed thermoplastic material at one or more regions of the foamed surface to cause reduction in roughness in said one or more regions, thereby obtaining a second light reflectivity of said one or more regions, said second light reflectivity being larger than said first light reflectivity.

Texturizing (or any lingual variation thereof) is meant to denote formation of one or more three-dimensional (3D) artifacts on the surface of an object, i.e. artifacts that extend out of the surface or depressed into the surface. The texturizing can be of an orderly pattern, a figure, an image and the like; or a random texture, e.g. mimicking a natural material such as wood, stone, clay, etc., or mimicking an artificial material, such as concrete. Within the context of the present disclosure, texturing also means to encompass various forms of marking a surface, for example, by letters, numbers, symbols, figures, etc.

The term roughness (or surface roughness or roughness grade, to be used herein interchangeably) is meant to denote a measure of irregularities of the surface compared to an ideal, smooth form of the surface. In other words, roughness is an averaged measure of the fine surface details, such as peaks, bumps, dents, valleys, etc. The higher the roughness value, the rougher the surface is, meaning that the surface details have a larger or more prominent amplitude.

The term light reflectivity (or light reflectance or reflectivity, to be used herein interchangeably) means to denote the relative amount of light that is reflected-off a surface. In the context of the present disclosure, light reflectivity means to denote reflectivity of light in the visible spectrum. Light reflectivity is impacted by and correlated to surface roughness—the higher the surface roughness, the lower the light reflectivity. A smooth surface typically causes incident rays of light impinging the surface to be reflected in an ordered manner, i.e. with the reflected rays being parallel to one another (what is known as “regular reflection”). Thus, the more reflected light arrives at the viewer's eye, the “glossier” and “darker” the color of the surface is perceived by the viewer. In comparison, a rougher surface will cause incident rays of light to be reflected at different angles due to the irregularity of the surface (what is known as “diffused reflection”) and thus be perceived by the viewer as a “lighter”, “brighter” or “duller” shade. Light reflectivity will also be referred to herein interchangeable as Specular Gloss, as measured according to ASTM D2457 (unless specifically indicated otherwise).

In articles produced according to processes of this disclosure, the differences in roughness and/or light reflectance are utilized to provide articles having a textured surface, in which regions of the surface have different roughness, and hence different light reflectance which is perceived by the viewer as different color shades.

According to some embodiments, the process increases the light reflectivity of said one or more regions by at least 20 Gloss Units (GU, as measured according to ASTM D2457). Hence, by some embodiments, the second light reflectivity is larger than said first light reflectivity by at least 20 GU.

By some embodiments, the first light reflectivity is at most 5 GU. By some other embodiments, the second light reflectivity is at least 25 GU.

In the processes of this disclosure, the surface is made of foamed thermoplastic polymeric material, the foaming resulting in a surface having a first degree of roughness. The foamed surface then undergoes a selective heating process, whereby one or more selected regions of the surface are exposed to heating conditions, thereby softening or melting the thermoplastic polymeric material in these one or more regions to cause smoothening or reduction in roughness grade in these regions. Thus, the desired texture or pattern characterized by different degrees of roughness (or light reflectance) is obtained on the surface.

Melting refers to a change in physical state of the thermoplastic polymeric material in which it transitions into a melt state between a solid state and a liquid state due to exposure to heat (i.e. as a result of temperature increase without exposure to any solvent). Thus, the processes of this disclosure utilize the melt state of the thermoplastic polymeric material, in which it is pliable, in order to locally alter its roughness in selected regions of the surface (e.g. reduce the roughness of the surface at desired regions thereof).

The regions can be of any size and shape, continuous or comprise of several non-continuous sub-regions on the surface. The regions can form an orderly pattern or an image, or can be of a random shape and/or random distribution on the surface.

By some embodiments, melting is obtained by contacting the foamed surface with at least one textured heated surface, said heated surface having a texture which has said second roughness grade. In other words, by causing local melting of the foamed surface by contacting it with a textured heated surface of said second roughness grade, the foamed surface is imprinted with the texture of the heated surface at said one or more regions that come into contact with the textured heated surface.

By some embodiments, said textured heated surface comprises a pattern having at least two zones differing therebetween by their roughness grades. According to such embodiments, said textured heated surface can comprise first zones having said second roughness grade, and second zones having a third roughness grade smaller than said second roughness grade. In other words, the contact of the foamed surface with the first zones will results in regions having said second roughness grade, while contact of the foamed surface with the second zones will results in regions having an even smaller roughness grade (i.e. said third roughness grade). By another example, the textured heated surface is designed such that each of said one or more regions has first and second zones, differing in their roughness grades.

According to some embodiments, the textured heated surface is a heated roller. According to other embodiments, the textured heated surface is a heated plate.

By some embodiments, the textured heated surface is heated to a temperature of at least about 140° C. By other embodiments, the textured heated surface is heated to a temperature in the range of between about 140°° C. and about 180° C.

It is to be noted that selective heating/melting can be obtained by other suitable techniques, such as laser etching, corona treatment, exposure to open flame, etc.

As noted, the surface is made of a thermoplastic polymeric material, which is a polymeric material that has a melting point and can be softened or melted by applying heat thereto. The term thermoplastic polymeric material means to includes homopolymers, copolymers, such as block, graft, random and alternating copolymers, as well as terpolymers, further including their derivatives, combinations and blends thereof. The term includes all geometrical configurations of such structures including linear, block, graft, random, alternating, branched structures, and combination thereof. The term also means to include blends or mixtures of two or more thermoplastic polymers. Non-limiting examples of such thermoplastic polymeric materials include polyolefins, polar thermoplastics, polystyrene, polyvinyl chloride (PVC), acrylonitrile-butadiene-styrene (ABS), styrene copolymers, polyacrylonitrile, polyacrylates, polyacrylamides, vinyl acetate polymers, vinyl alcohol polymers, cellulose plastics, thermoplastic elastomers, thermoplastic polyurethanes, polyester-based thermoplastic elastomers, thermoplastic polyesters, polyethylene terephthalate, polybutylene terephthalate, compatibilized thermoplastic blends, polyacetal, polyethers, polyarylates, polycarbonates, polyamides, polyimides, polybenzimidazoles, aromatic polyhydrazides and polyoxadiazoles, polyphenyl-quinoxalines, polyphenylene sulfide, polyphenylene vinylene, conducting thermoplastics, conducting thermoplastics composites, poly(aryl ether sulfone)s, poly(aryl ether ketone)s, poly(aryl ether ketones-co-sulfones), poly(aryl ether ketone amide)s, polytetrafluoroethylene and mixtures thereof

By some embodiments, said thermoplastic polymeric material is a composition comprising one or more polyolefins or copolymers thereof.

By some embodiments, said thermoplastic polymeric material is a composition comprising polyethylene, polypropylene or a copolymer or mixture thereof.

By some embodiments, said thermoplastic polymeric material is a composition comprising polypropylene or a copolymer or mixture thereof.

The thermoplastic polymeric material is foamed, to obtain a foamed surface. The term foam (or any lingual variation thereof) refers to a cellular structure containing pores that are connected to one another and form an interconnected 3-dimensional network.

By some embodiments, the foamed thermoplastic polymeric material is a closed cell foam.

By some embodiments, foamed thermoplastic polymeric material is obtained by exothermal foaming. Exothermal foaming is obtained by chemical reaction or decomposition of a blowing agent, and is characterized by release of gas and energy (mainly in the form of heat) during said reaction. Volumetric expansion, or foaming, of the thermoplastic polymer is therefore obtained due to the formation and expansion of the gaseous decomposition products; as the exothermal reaction generates heat, it is, in fact, self-propagating. In other words, after an initial heating stage to initiate reaction, once sufficient heat is released due to the reaction, no further external heating needs to be provided and the foaming reaction self-propagates. This makes the utilization of exothermal blowing agent more cost-effective and reduces the overall energy invested in the process.

According to some embodiments, the thermoplastic polymeric material is a composition comprising at least one thermoplastic polymer and at least one exothermal blowing agent. The exothermal foaming stage comprises exposing the composition to conditions permitting exothermal decomposition of the blowing agent to obtain the foamed thermoplastic polymeric material.

According to some embodiments, the conditions under which the exothermal foaming is carried out are a temperature ranging between about 170° C. and about 220° C.

The exothermal blowing agent can, by some embodiments, be selected from azodicarbonamide (ADC); 4,4-oxybis benzene sulfonyl hydrazide (OBSH); p-toluene sulfonyl hydrazide (TSH); 5-phenyltetrazole (5-PT); p-toluene sulfonyl semi carbazide (PTSS); di nitroso Penta methylene tetraamine (DNPT), and any mixture thereof.

It is to be understood that the blowing agent can be utilized as is, namely as a pure material, or can be introduced into the thermoplastic polymeric material in formulated form, typically as a formulation of carrier particles (which can be made of a thermoplastic polymer) coated by or embedding said blowing agent.

The thermoplastic polymeric material can further comprise one or more additives, e.g. functional additives, that are used to endow the thermoplastic polymeric material with one or more desired properties. Such functional additives can be, for example, pigments, reinforcing fibers or particles, fillers, UV-stabilizers, UV-absorbers, plasticizers, antistatic agents, antioxidants, flame retardants, minerals, biocides, etc.

According to some embodiments, the process further comprises printing one or more printing ink layers over at least one portion of the textured surface, to provide further texturing or provide one or more additional visual effects. While typical printing over plastic surfaces requires the use of one or more priming layers to increase adhesion of the printing ink to the polymeric surface, the roughness of the textured surface obtained by processes of this disclosure permits mechanical fixation or locking of the printing ink into the rough surface structure. Hence, further visual texturing can be obtained by printing one or more ink layers onto the textured surface.

Printing can be carried out by any suitable technique, such as digital printing, screen printing, flexography, litho-printing, or transfer printing. According to some embodiments, said printing is digital printing.

According to some embodiments, the textured surface is a surface of an extruded panel.

By some embodiments, the extruded article is made of said foamed thermoplastic polymeric material, i.e. is constituted in its entirety out of the foamed thermoplastic polymeric material.

By other embodiments, the extruded panel comprises a core made of a non-foamed thermoplastic material, and the foamed surface is made of said foamed thermoplastic polymeric material. According to such embodiments, the non-foamed thermoplastic material is a composition comprising polypropylene, polyethylene, or a co-polymer or a blend thereof.

By some other embodiments, the extruded panel comprises a core made of non-polymeric thermoplastic composition, that is at least partially coated by the foamed thermoplastic polymeric material.

According to some embodiments, the extruded article is manufactured by co-extrusion of a core material and said thermoplastic polymeric material coating said core material

According to some embodiments, said extrusion and/or co-extrusion is carried out under conditions permitting said foaming during extrusion.

By another one of its aspects the disclosure provides a process for obtaining a pattern on a foamed surface, the foamed surface being made of a foamed thermoplastic polymeric material and having a first roughness grade, the process comprising melting the foamed thermoplastic material at one or more regions of the foamed surface to cause reduction of roughness in said one or more regions to a second roughness grade, thereby obtaining said pattern.

A further aspect of this disclosure provides a process for patterning a foamed surface of an article, the foamed surface being made of foamed thermoplastic polymeric material and having a first light reflectivity, the process comprising melting the foamed thermoplastic material at one or more regions of the foamed surface to cause reduction in roughness in said one or more regions, thereby obtaining a second light reflectivity of said one or more regions, said second light reflectivity being larger than said first light reflectivity.

By yet another aspect, the disclosure provides an article of manufacture having a surface made of foamed thermoplastic material having a first roughness grade and comprising one or more regions having a second roughness grade, the second roughness being smaller than the first roughness grade, the article being manufactured according to the processes disclosed herein.

As used herein, the term about is meant to encompass deviation of ±10% from the specifically mentioned value of a parameter, such as temperature, pressure, concentration, etc.

Whenever a numerical range is indicated herein, it is meant to include any cited numeral (fractional or integral) within the indicated range. The phrase ranging ranges between a first indicate number and a second indicate number and ranging ranges from a first indicate number to a second indicate number are used herein interchangeably and are meant to include the first and second indicated numbers and all the fractional and integral numerals therebetween.

It is appreciated that certain features, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B are schematic illustrations of regular reflection and diffuse reflection of light from a surface, respectively.

FIGS. 2A-2B show extrusion molded polypropylene composition panels produced according to an embodiment of the process of this disclosure, where FIG. 2A shows the foamed surface of the panel, and FIG. 2B shows the finished panel after melting regions of the foamed surface to obtain a pattern.

FIG. 2C shows a textured heated roller utilized in a process according to an embodiment of this disclosure.

FIGS. 3A-3B illustrate the surface structure of an article produced according to a process of this disclosure (FIG. 3A) and a close-up thereof (FIG. 3B).

FIG. 4 illustrates an exemplary section of a heated textured roller utilized in an embodiment of a process according to this disclosure.

FIG. 5 shows an extrusion molded polypropylene composition panel without a foamed surface, onto which surface melting has been employed.

FIG. 6 shows an extruded wood-plastic composition (WPC) without a foamed surface, onto which high pressure mechanical embossing has been employed.

### DETAILED DESCRIPTION OF EMBODIMENTS

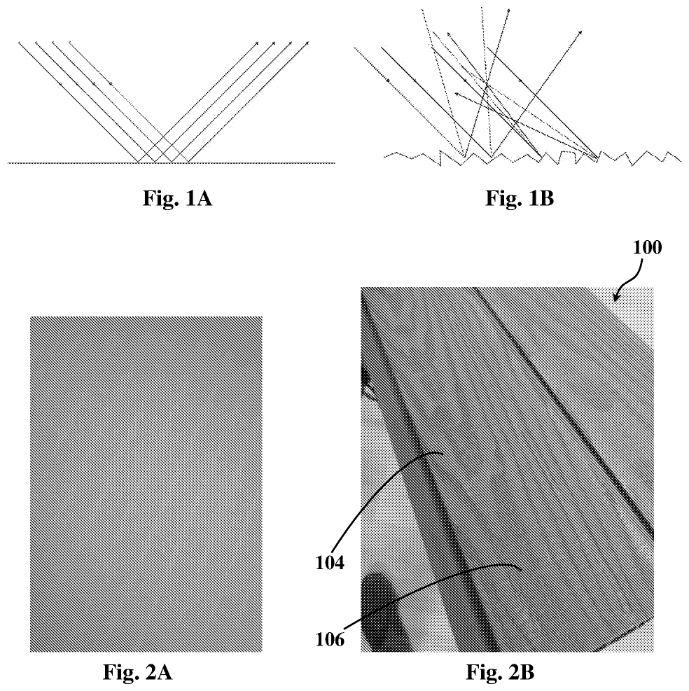

As noted, the processes of this disclosure enable obtaining a textured surface of an article, with regions of different roughness and light reflectivity, to obtain various visual effects. As shown in FIGS. 1A-1B, the roughness of a surface impacts the shade of color perceived by a viewer. Regular reflection of light is obtained from smooth surfaces, in which incident rays of light impinging the surface are reflected in a parallel, ordered manner, as illustrated in FIG. 1A. In regular reflection, more reflected light arrives at the viewer's eye and hence the surface color is perceived by the user as being “darker” or of a dark shade. In comparison, a rougher surface, as illustrated in FIG. 1B, will cause incident rays of light to be reflected at different angles due to the irregularity of the surface (diffused reflection) and thus be perceived by the viewer as “lighter” or “brighter” shade.

Processes of this disclosure enable providing a surface with differences in roughness and/or light reflectance, thereby obtaining articles having a texturized or patterned surface, in which regions of the surface have different roughness, and hence different light reflectance which is perceived by the viewer as different color shades.

### Example 1

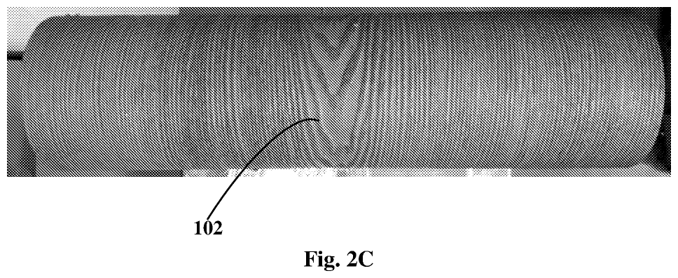

Shown in FIG. 2A is a surface of a panel made by coextrusion of foamed thermoplastic polymeric material, in this specific example a composition comprising polypropylene as a main component and azodicarbonamide (ADC) as an exothermic blowing agent. The material temperature at the co-extruder was 170-220° C., and the material was maintained within the co-extruder for a pre-defined period of time before extruding through the extrusion die to allow the ADC to decompose and form the foamed external surface of the panel.

Following extrusion, the foamed surface of the panel was transported under a textured heated roller, an example of which is shown in FIG. 2C. As can be seen, regions of the roller, generally designated 102, were textured and caused transfer heat to the foamed surface at controlled manner. The roller was heated to a temperature of about 140° C., and when rolled over the foamed surface of the panel, local melting of the polypropylene was obtained, thereby “smoothening” the surface in these regions and imparting them with a roughness grade and texture according to that of regions 102. Hence, panel 100, as seen in FIG. 2B, has regions of a high roughness grade, generally designated 104 originating from the foaming (perceived by the viewer as having a lighter shade), and regions 106 of a smaller roughness grade (perceived by the viewer as having a darker shade) due to the melting and smoothing imparted by the textured heated roller.

As can clearly be seen in FIG. 2B, regions 106 are visibly darker than regions 104 due to the differences in roughness grades.

The light reflectance from the different regions was measured according to ASTM D2457. In regions 104 the light reflectance was at most 5 GU, while in regions 106 the light reflectance was at least 25 GU. While the panel had the same color along it entire surface, this difference in reflectance (caused by difference in roughness) caused regions 104, having a higher degree of roughness, to be perceived as having a “lighter” or “duller” shade compared to regions 106 who have a lesser roughness and are perceived as having a “darker” or “glossier” shade of the same color.

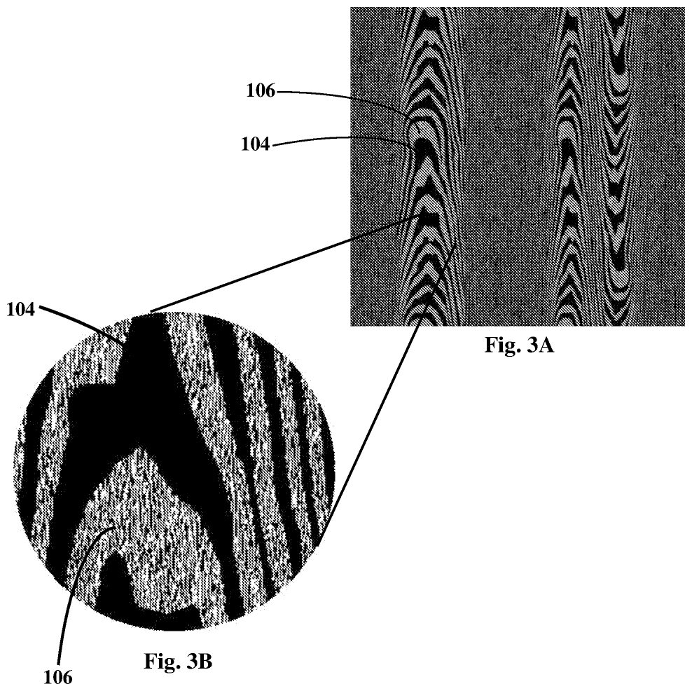

As clearly visible from FIGS. 2B, 3A and 3B, the process enables careful control of surface roughness, thereby enabling imparting the extruded panel with a desired texture, mimicking, in this specific example, a natural wood panel texture and grain at a high accuracy.

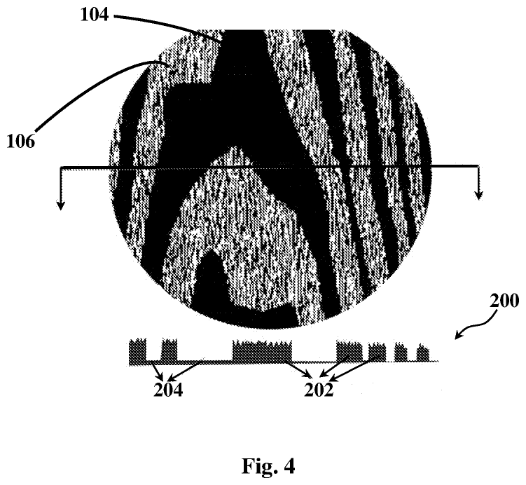

Seen in FIG. 4 is a close-up view of an illustrated section of the roller with an illustration of a corresponding profile 200 of the heated textured roller. Zones 202 of the roller have a roughness grade that is smaller than the roughness of the foamed surface of the panel, and protrude from the surface of the roller, such that zones 202 come into contact with the foamed surface of the panel when the roller is rolled over the surface. The pre-defined texture of zones 202 also enable to control the heat transfer to the surface of the panel once contact between the roller and the foamed surface to be textured is obtained, thereby avoiding over-melting the foamed surface and hindering the desired texture. As the roller is heated, the thermoplastic polymeric material constituting the surface of the panel undergo local melting, and are imparted with the roughness and texture of zones 202 to obtain regions 106 of a smaller roughness grade and darker shade. Zones 204 of the roller, however, constitute gaps between zones 202, in which the roller does not come into contact with the surface of the panel, leaving the original, higher roughness foamed texture untreated, thereby obtaining regions 104 having a lighter shade.

### Example 2—Reference Example

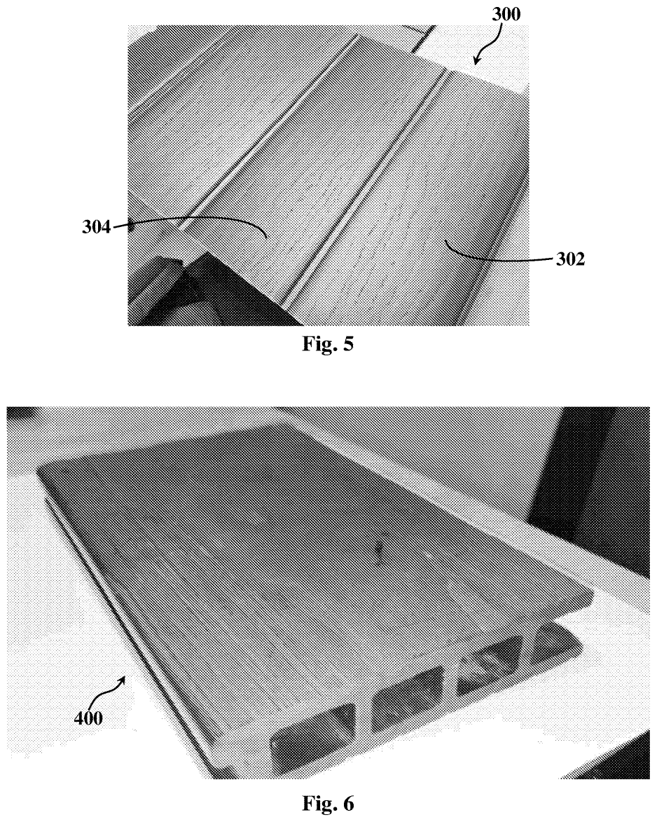

Seen in FIG. 5 is an extrusion panel 300 made of the same polypropylene composition of Example 1, however, without the blowing agent. This panel was treated by the heated textured roller of Example 1 under the same conditions to obtain a textured panel 300. As can be seen in FIG. 5, almost no difference in shade of color can be seen between regions 302, which constitute the original, smooth surface of the panel, and regions 304 which are the regions that came into contact with the heated roller.

### Example 3—Reference Example

Seen in FIG. 6 is an injection molded panel 400 made of the same polypropylene composition of Example 1, however, without the blowing agent. This panel was treated by high pressure and heated mechanical embossing. As can be seen in FIG. 6, while a pattern is visible on the surface of the panel, almost no difference in shade of color can be observed.

1. A process for texturizing a surface made of a thermoplastic polymeric material to obtain a textured surface having regions of different roughness, the process comprising:
providing a foamed surface made of foamed thermoplastic polymeric material, the foamed surface having a first roughness grade; and
melting the foamed thermoplastic material at one or more regions of the foamed surface to cause reduction of roughness in said one or more regions to a second roughness grade, thereby obtaining the textured surface,
wherein said melting is obtained by contacting said foamed surface with at least one textured heated surface, said heated surface having a texture which has said second roughness grade, said textured heated surface is heated to a temperature of at least about 140° C.

2. (canceled)

3. (canceled)

4. The process of claim 1, wherein said textured heated surface comprises a pattern having at least two zones differing therebetween by roughness grade.

5. The process of claim 4, wherein said textured heated surface comprises first zones having said second roughness grade, and second zones having a third roughness grade smaller than said second roughness grade.

6. The process of claim 1, wherein said textured heated surface is a heated roller.

7. The process of claim 1, wherein said thermoplastic polymeric material is a composition comprising polypropylene or a copolymer thereof.

8. The process of claim 1, wherein said foamed thermoplastic polymeric material is obtained by exothermal foaming.

9. The process of claim 8, wherein said thermoplastic polymeric material is a composition of one or more thermoplastic polymers and one or more exothermal blowing agents, said exothermal foaming comprises exposing said composition to conditions permitting exothermal decomposition of said exothermal blowing agent to obtain said foamed thermoplastic polymeric material.

10. (canceled)

11. The process of claim 1, wherein said textured surface is a surface of an extruded article.

12. The process of claim 11, wherein said extruded article is made of said foamed thermoplastic polymeric material.

13. The process of claim 11, wherein said extruded article comprises a core made of a non-foamed thermoplastic material, and said surface is made of said foamed thermoplastic polymeric material.

14. (canceled)

15. The process of claim 11, wherein said extruded article comprises a core made of non-polymeric thermoplastic composition, coated by said foamed thermoplastic polymeric material.

16. The process of claim 13, wherein said extruded article is manufactured by co-extrusion of the foamed thermoplastic polymeric material onto the core.

17. The process of claim 1, further comprising digitally printing one or more printing inks over at least one region of the textured surface.

18. A process for providing an article having a textured surface comprising regions of different light reflectivity, the process comprising:
providing a foamed surface made of foamed thermoplastic polymeric material to obtain a first light reflectivity of the surface; and
melting the foamed thermoplastic material at one or more regions of the foamed surface to cause reduction in roughness in said one or more regions, thereby obtaining a second light reflectivity of said one or more regions, said second light reflectivity being larger than said first light reflectivity
wherein said foamed surface has a first roughness grade, and said melting is obtained by contacting said foamed surface with at least one textured heated surface, said heated surface having a texture which has at least one second roughness grade, said heated surface comprising a pattern having at least two zones differing therebetween by roughness grade.

19. The process of claim 18, wherein said second light reflectivity is larger than said first light reflectivity by at least 20 Gloss Units (as measured according to ASTM D2457).

20. (canceled)

21. (canceled)

22. The process of claim 18, wherein said heated surface comprises first zones having said second roughness grade, and second zones having a third roughness grade smaller than said second roughness grade.

23. The process of claim 18, wherein said textured heated surface is a heated roller.

24. The process of claim 18, wherein said thermoplastic material is a composition comprising polypropylene or a copolymer thereof.

25. The process of claim 18, wherein said foamed thermoplastic polymeric material is obtained by exothermal foaming.

26. The process of claim 25, wherein the thermoplastic polymeric material is a composition of one or more thermoplastic polymers and one or more exothermal blowing agents, said exothermal foaming comprises exposing said composition to conditions permitting exothermal decomposition of said exothermal blowing agent to obtain said foamed thermoplastic polymeric material.

27. The process of claim 18, wherein said article is obtained by extrusion.

28. The process of claim 18, wherein said article is made of said foamed thermoplastic polymeric material.

29. The process of claim 18, wherein said article comprises a core made of a non-foamed thermoplastic material, and said surface is made of said foamed thermoplastic polymeric material.

30. The process of claim 29, wherein said article is obtained by co-extrusion.

31. (canceled)

32. (canceled)

33. (canceled)
